(19) United States
(12) Patent Application Publication
(10) Pub. No.: US 2009/0271970 A1
(43) Pub. Date: Nov. 5, 2009

(54) Panel mounting clip

(75) Inventors: Ronald Charles Hanley, Auckland (NZ); Gregory John Kelly, Auckland (NZ)

Correspondence Address: JACOBSON HOLMAN PLLC, 400 SEVENTH STREET N.W., SUITE 600, WASHINGTON, DC, 20004, US

(73) Assignee: FASTMOUNT LIMITED, Auckland (NZ)

(21) Appl. No.: 12/385,948

(22) Filed: Apr. 24, 2009

Related U.S. Application Data
(63) Continuation of application No. 11/155,893, filed on Jun. 20, 2005, now abandoned.

(30) Foreign Application Priority Data
Oct. 28, 2004 (AU) 2004224882

(51) Int. Cl. B23P 11/00

(52) U.S. Cl. 29/525.02

(57) ABSTRACT

A method of installing panels includes temporarily securing un-upholstered panels in place on an underlying support and marking the underlying support at each of a plurality of panel clip locations on the panel. The panel is removed from the support structure for upholstering. The support structure is drilled at the marks to provide a hole to receive a socket component, and a socket component is driven into each of the receiving holes in the support structure. The socket component includes a cup open to at least one end, an external thread for engaging the support structure, and a constriction in the cup spaced away from the bottom of the cup. A plug component is secured at each of the panel clip locations on the panel, the plug component having a protruding portion to engage in the socket. The upholstered panel is lifted into position and the periphery is pressed into place to engage the protruding portions of the plug components within the cups of the sockets.

### BACKGROUND TO THE INVENTION

1. Field of the Invention

The present invention relates to devices and arrangements for removably mounting panels to underlying support structures.

2. Summary of the Prior Art

In the luxury boat and yacht industry there is a general desire for wall and/or ceiling panels to be fixed in place but able to be removed and reinstated as necessary for maintenance and refurbishment or for accessing areas behind the panels. In a typical construction the panels are mounted to a wooden framework affixed to the hull. Typically each panel is a plywood panel upholstered or veneered on its outer face and edges. One current approach for fixing the panels to the framework involves large quantities of hook and loop fastener material such as VELCRO. Lines of the hook material are secured to one of the panel or framework and corresponding lines of the loop material are applied to the other of the panel and framework. The panel is lifted into place, positioned and pressed against the framework to engage the hook and loop components. This hook and loop attachment has the disadvantages that security of the connection can deteriorate over time, the effectiveness of the hooks and/or loops can deteriorate over repeated removal and reinstatement, the panels must be located by eye during reinstatement and can end up inaccurately mounted, the depth of mounting of the panel relative to the framework is not always consistent and a great quantity of the fastener material is required to securely hold the panels in place with an associated high cost in materials and labour.

### SUMMARY OF THE INVENTION

It is an object of the present to provide panel mounting arrangements and elements thereof which at least go some way toward overcoming the above disadvantages or which will provide the public with a useful choice.

Accordingly in one aspect the present invention consists in a fastener for mounting a panel to a support, the fastener comprising:

a socket component having a cup open to at least one end, an external spiral thread, the axis of said spiral thread being substantially parallel with the open direction of said cup, the wall of said cup providing a constriction or throat spaced from the bottom of the cup; and

a plug component having a base with an external spiral thread, and a protrusion from said base extending substantially coaxial with the axis of said thread, said protrusion including a head portion distal from said base, said protrusion sized to enter said cup of said socket component and said head portion sized to interfere with said throat but to be forcible past said throat.

In a further aspect the present invention consists in a tool for use with a fastener including a socket component for embedding in a support member leaving an open cup exposed, said tool including:

a body shaped to engage in the open end of said cup and bear on said socket to prevent insertion beyond a predetermined depth, and

a point extending from said body, positioned so as to be centrally located relative to said hollow, and oriented to extend away from said hollow, with said body engaged in a said hollow.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

FIG. 1 is a side elevation in cross section of a panel clip according to the present invention comprising a male component, with a ball, engaged in a female component, the socket.

FIG. 2 is a cross sectional side elevation through panels and support structure using the panel clip of FIG. 1, illustrating application of the panel clip of FIG. 1 for mounting panels to a support structure.

FIG. 3 is a cutaway isometric view of mounted panels in accordance with the arrangement in FIG. 2.

FIG. 4 is an isometric view of the socket of FIG. 1 from one end.

FIG. 5 is a perspective view of the socket of FIG. 1 from the other end.

FIG. 6 is a perspective view of the ball of FIG. 1.

FIG. 7 is a side elevation of the ball of FIG. 1.

FIG. 8 is a perspective view of a centre point insert for use with the socket of FIG. 1.

FIG. 9 is a cross sectional side elevation of the socket of FIG. 1 with the centre point insert of FIG. 8.

FIG. 10 is a side elevation of a tool for assisting the installation of the ball of FIG. 1.

FIG. 11 is an isometric view of the tool of FIG. 10.

FIG. 12 is a side elevation of a tool for assisting installation of the socket of FIG. 1.

FIG. 13 is an isometric view of a drill for assisting installation of the socket and the ball of FIG. 1.

### DETAILED DESCRIPTION

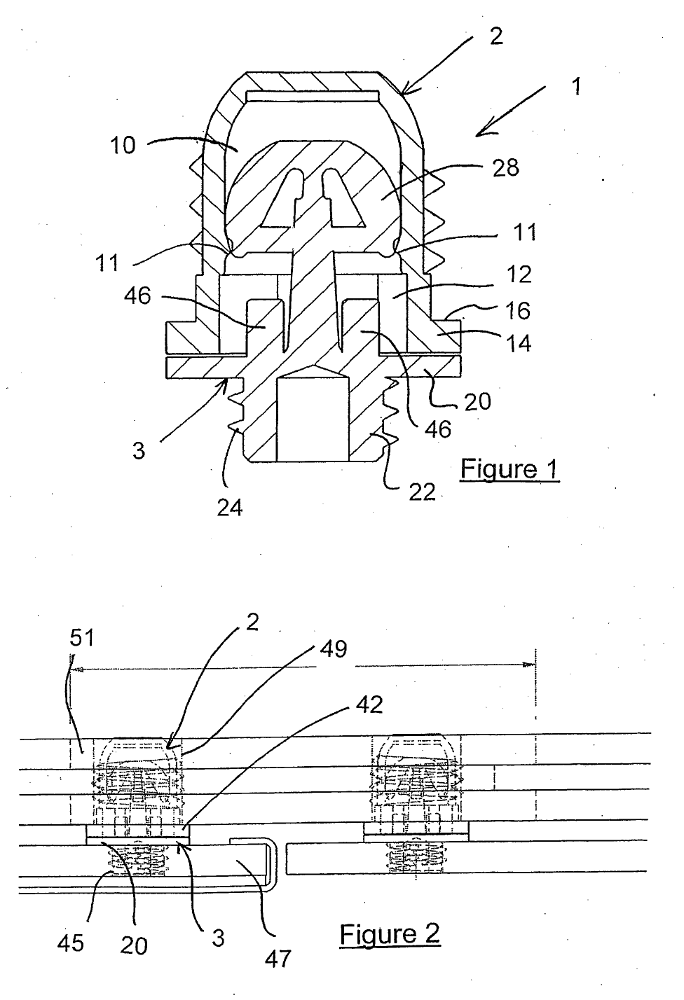

According to one preferred aspect the present invention comprises a fastener for mounting a panel to a support. The invention will be particularly described with reference to the type of panel and type of support commonly found in luxury boats and yachts, however it would be appreciated that the invention can equally be applied to mounting panels in other situations, such as high quality interior fit-outs for buildings of various type. According to the preferred embodiment of the invention the fastener is in the form of a panel clip as illustrated in FIG. 1. The panel clip 1 includes a socket component 2 and a plug component 3. In use one of the socket component and plug component is fitted to the supporting structure and the other is fitted to the panel for mounting on the supporting structure. Typically the panel is thinner than the supporting structure and accordingly the socket component 2 is mounted in the supporting structure and the plug component 3 is mounted to the panel.

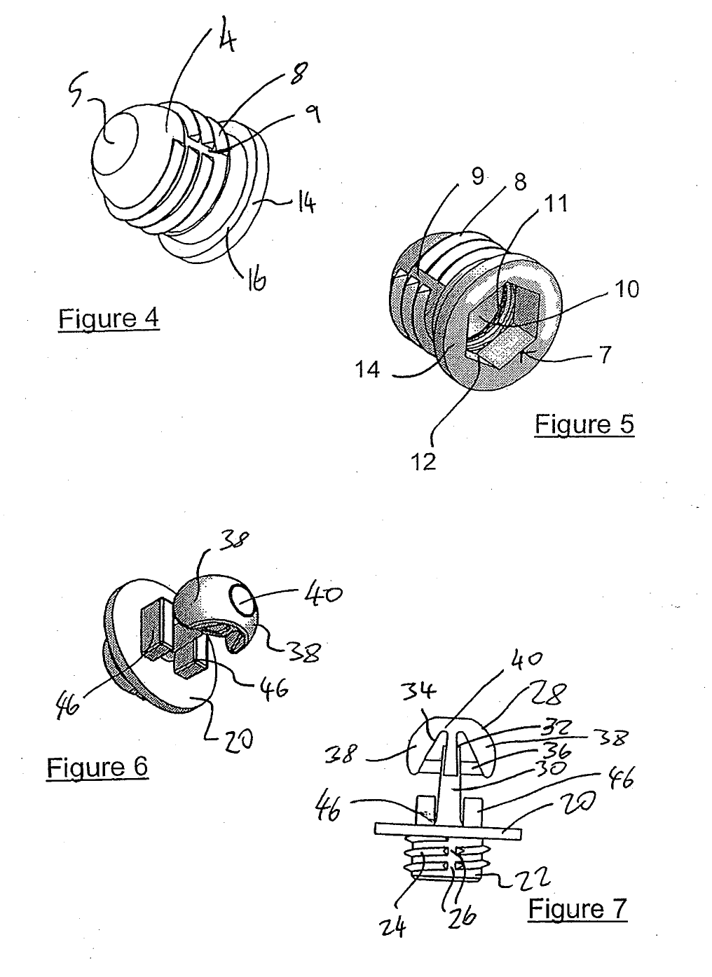

The socket component 2 is particularly illustrated in FIGS. 1, 4 and 5. The socket comprises. a thin walled body in the general form of an open ended cup. The cup may taper, at 4 to closed end 5. Taper 4 eases installation of the socket into a predrilled aperture, aligning the socket as it is driven into place. A thread 8 is provided on the external surface of the cup. The spiral thread 8 is preferably formed to allow self-tapping into soft and medium wood. We have found that this can also be effective to secure the socket into plastic or glass reinforced plastic. For thin section metals the socket can still be used, secured in place through an oversized hole by a nut threading onto the portion of the socket fitted through the hole. To enhance the self-tapping capability of thread 8 the thread may be provided as a series of spiral sections, for example divided by breaks 9. The thread may be integrally formed with the body of the socket of the same plastic. Alternatively the thread may be provided as a metal insert, making the socket even more useful where the intended substrate material is particularly hard.

The open cup of socket component 2 includes a substantially cylindrical chamber 10. An annular lip 11 protrudes inwards adjacent the entrance to cylindrical chamber 10. Between the annular lip 11 and the open end of the cup the cup wall is formed in the shape of a hexagonal socket 12. At the open end of the cup the thin wall of the socket component extends outward as flange 14. The intended inward face 16 of flange 14 buts against the face of the supporting framework once the socket is fully installed.

The plug component 3 is particularly illustrated in FIGS. 1, 6 and 7. The plug component includes a base portion for mounting to the panel and a protruding portion for fixing into the socket component. In the preferred embodiment the base portion includes a flange 20 and a substantially cylindrical body 22 extending from one face of the flange. The substantially cylindrical body 22 has an external thread 24. The external thread 24, like external thread 8 is preferably self-tapping into soft and medium timber. To these ends the spiral thread 24 may be a series of short sections divided as at gaps 26. The protruding portion of the plug component extends from the opposite face of flange 20. The protruding portion includes a head 28. The head 28 is sized and shaped to fit within the cylindrical portion 10 of the cup of socket component 2. The head 28 is sized and shaped to not fit easily past the protruding lip 11 within the cup of socket component 2. The protruding lip 11 effectively forms a constricted throat. The head 28 can only pass the constricted throat upon application of sufficient force to temporarily elastically deform either the head portion of plug 3 or the body of socket 2. It will be seen in FIG. 1 that the minimum diameter of the cup at the annular lip 11 is somewhat less than the full width of head 28 of plug 3. In fact in the illustration of FIG. 1 the two components are illustrated in their unstressed form and there is seen to be some overlap between the head portion 28 and the lip 11.

In the preferred embodiment the plug component 3 is formed so as to provide for a degree of lateral flexibility to allow tolerance in the relative mounting of the plug and socket components for any given panel. In the illustrated embodiment this is provided by a cantilever support 30 for head portion 28. The support 30 extends from the face of flange 20. The support 30 is centrally located relative to flange 20 and is comparatively narrow relative to the head 28. The head 28 is supported from the free end of cantilever 30. Preferably connected with cantilever 30 adjacent the apex 32 within a cavity 34 in the rear face of the head portion 28. Stabilising bridge portions 36 may be provided between the cantilever 30 and the head portion 28 further back from the apex 32. The bridge portions 36 may stop general canting of the head portion 28 about the apex 32 but allow for compression of the head portion 28 during engagement into socket 2. To these ends the head portion 28 preferably comprises a pair of curved wings 38 connected at a crown 40 adjacent the apex 32. Viewed from above crown 40 the head portion appears as a circle with a pair of parallel segments removed.

Between each wing 38 and the flange 20 the plug component 3 includes a substantially oblong upstand 46. The upstands 46 provide a means for engaging the plug component to drive it during installation. In particular the ends of the upstands end flush with the flattened sides of the head portion 28 so that a complementary socket past over the head portion 28 can engage against the end of the upstand walls.

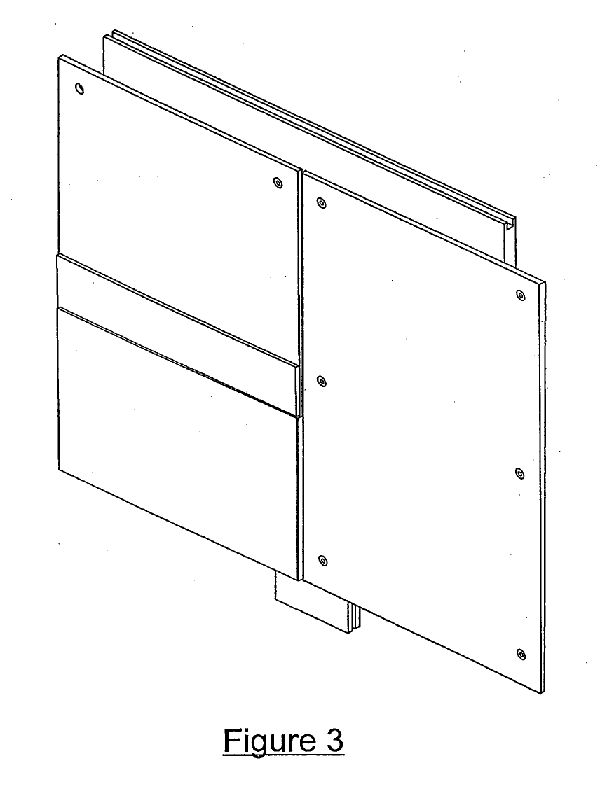

The panel clips illustrated in their installed form in FIGS. 2 and 3. FIG. 2 illustrates the installation of the clip, with the plug component 3 fixed into an aperture 45 in an upholstered panel 47. The flange 20 buts the inner surface of the panel 47. The socket component 2 is fitted in a aperture 49 in support member 51. The flange 14 of socket 2 has its rear surface 16 butting against the outer surface of support member 51. The apertures 45 and 49 preferably comprise predrilled holes sized specifically to take the respective component and allow the respective component to engage in the hole by the self-tapping spiral threads. This is preferred due to its simplicity of installation and the ease with which broken or damaged socket or plug components can be removed and replaced.

It is with this preferred installation method (threading to place) in mind that the socket is provided in an substantially cylindrical form, so that relative orientations of the socket component and plug component are not a factor when fitting the panel.

FIG. 3 illustrates the general layout of panel clips in relation to panels on a supporting structure, with panel clips provided at intervals around the perimeter of panels.

Typical installation of the panel clips will proceed as follows:
The un-upholstered panels will be temporarily secured in place on the underlying support. For example it may be temporarily screwed to the support as the exposed surfaces of the panel will subsequently be upholstered to obscure any resulting marks or holes.
A pilot hole is drilled at each panel clip location through the panel and into the underlying support. Alternatively the appropriately dimensioned hole for the mounting portion of the plug component can be drilled through the panel and sufficiently further to at least mark the underlying support.
The panel is then removed and upholstered or finished as required.

Each of the pilot holes or marks in the support structure is drilled out sufficient to provide a hole to receive a socket component.

A socket component is driven into each of the receiving holes in the support structure, a plug component is driven into each of the receiving holes in the upholstered panels when these return from upholstering.

The panels may then be fitted by lifting to position and pressing the periphery into place to engage the protruding portions of the plug components within the cups of the sockets. The panel may be removed by prising it away from the supporting structure with sufficient force to disengage the protruding portion of the plug components from the cups of the socket components. In the unlikely event that any plug component or socket component is damaged in removing a panel it can be simply unscrewed and replaced by screwing in a replacement component.

To aid in this installation process in further aspects the present invention comprises certain assisting tools.

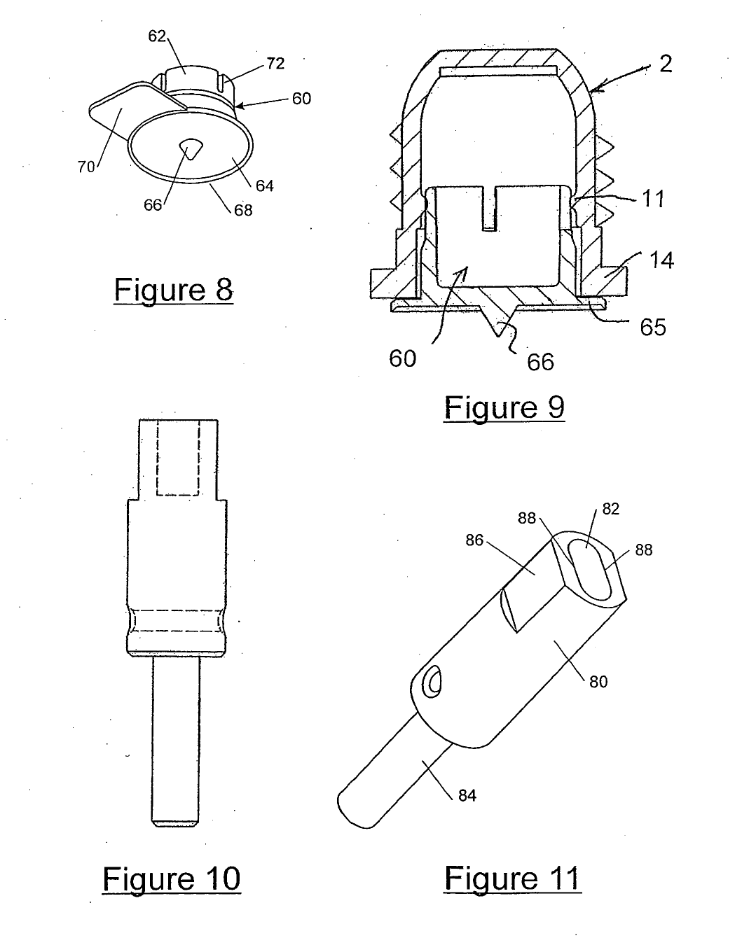

A first tool, illustrated in FIGS. 8 and 9 is provided to assist where there is a requirement for installing plug components on a panel that is already upholstered. In that situation the socket components (or additional socket components if it is for the addition of additional clips for a pre-existing panel) is first installed in the supporting structure. A centre marking tool 60 is then fitted to the socket 2. The panel is lifted into place and pressed against the socket and the marking tool 60 leaves an impression in the reverse face of the panel. This impression marks the centre for drilling a receiving hole for the plug component. The marking tool 60 comprises a body portion 62 which inserts into the open hollow of the socket. The body portion 62 preferably comprises a substantially cylindrical wall which can resiliently engage against the annular lip 11. Preferably, like the socket component 2 and plug component 3, the marking tool 60 is made of a hard plastic. Accordingly the cylindrical wall 62 includes a series of breaks 72 to allow some flexibility in the region of its upper edge.

The cylindrical wall 62 is capped by an end 64 which includes an outwardly extending flange 65. The outwardly extending flange 65 overlaps the flange 14 of the socket component and prevents over insertion of the tool 60 into the socket component. The tool 60 includes one or more protruding features to leave an indent in a panel that is pressed against it. Most importantly these protruding features include a protruding centrepoint 66. This centrepoint 66 is centrally located on the face 64 so that it is centred relative to the socket component 2 with the body 62 of the tool engaged in the socket component. Preferably there is also a protruding rim 68 around the periphery of the flange 64.

To assist removal of the marking tool 60 from the socket 2 an outwardly extending tab 70 is provided extending from the flange portion 65. A user may pull on the tab 70 and the tool 60 will come free.

FIGS. 10 and 11 illustrate a further tool, being a driver for installing plug components according to the preferred embodiment of the present invention. The driver includes a body 80 with a socket 82 at one end and a chuck engageable shaft 84 extending from the other end. The chuck engageable member 84 and the socket 82 are preferably co-axial so that rotation of the tool with the chuck engageable member 84 engaged in for example a drill, has the body 80 and socket 82 rotating about its longitudinal axis. Preferably, to substantially match the form of the protruding portion of the plug component the socket 82 comprises an oval hole of substantially constant cross-section. Preferably the overall hole has straight sides 88 separated by the same distance as the width of head portion 28 and/or length of oblong upstand walls 46, so that in use the flat sides 88 of socket 82 drive against the ends of walls 46 when the protruding portion of the plug component is fitted into the socket 82. The driver may also be provided with flats 86 to be engaged by, for example, a spanner, in the case that a suitable driver is not available or cannot be used due to space constraints. It will also be appreciated that a spanner may be used directly on the oblong upstand walls 46 if necessary.

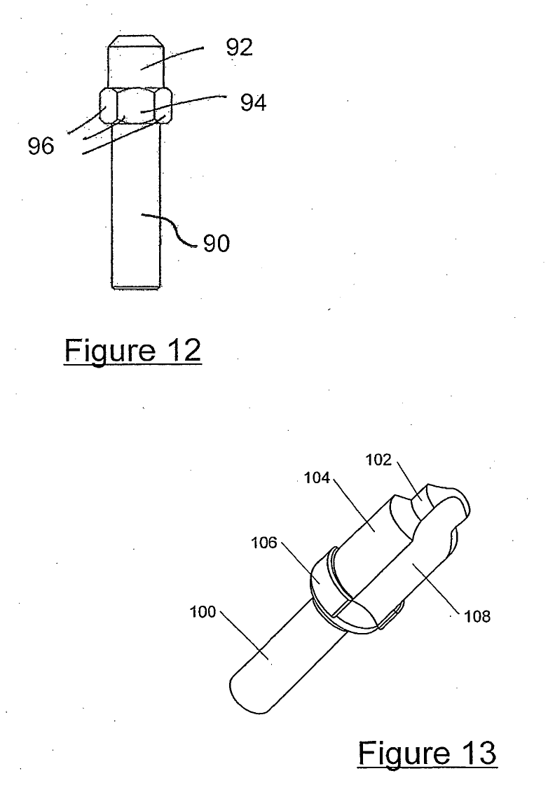

A further tool illustrated in FIG. 12 is adapted for driving home the socket components of the preferred embodiment of the present invention. This driver includes a chuck engageable shaft 90, a head 92 and a collar 94. The head 92 is sized to fit within the cylindrical cup portion 10 of socket component 2. It may be sized to slightly engage with the protruding lip 11 so that the socket is held in place on the driver. The collar 94 is formed to engage in the driving socket 12 of the socket component 2. For example in the illustrated form the driving socket 12 of socket component 2 is provided as an open hexagonal socket with six flats. Accordingly the collar 94 is provided as a complementary shape and size having six matching outward flat 96. In use the tool can be fitted and secured in the chuck of for example a cordless handheld screwdriver and socket components can be installed by, for each component, fitting the component over the head 92 until the collar 94 engages in socket 12, driving the component into place using the cordless screwdriver, then pulling the cordless screwdriver and tool free from the installed socket component.

A further tool, illustrated in FIG. 13, comprises a drill bit specifically adapted for installing a two-part fastening such as that of the preferred embodiment. The drill bit has a chuck engageable shaft 100, a first drill portion 102 of a first diameter and a further drill portion 104 of a second diameter. The diameter of drill portion 102 is less than the diameter of drill portion 104. Preferably the diameter of drill portion 102 is of the dimension required to drill a hole for mounting the plug component of the present invention and the diameter of the second portion 104 is dimensioned to drill a hole for installing the socket component of the present invention. A collar 106 is provided between the drill portion 104 and the chuck engageable shaft 100 to provide a depth limit.

The drill thus described is preferably of the form having a cylindrical type body with one or more axial rebates 108, with the cutting edge comprising the edge between a wall of the rebate 108 and the outer surface of the body. It will be appreciated in the present configuration the body is not so much cylindrical as a series of cylindrical portions connected by frusto-conical steps.

The plug component 3, socket component 2 and marking component 60 have been described as being preferably formed from a rigid plastic material. A suitable rigid plastic material may for example comprise a suitable acetylplastic. These plastic components are preferably produced by injection moulding. The other tools, illustrated in FIGS. 10 to 13 are preferably formed from a tool steel and may be manufactured in any suitable manner which will be readily apparent to persons skilled in the art.

1-20. (canceled)

21. A method of installing panels comprising:
temporarily securing un-upholstered panels in place on an underlying support,
marking the underlying support at each of a plurality of panel clip locations on the panel,
removing the panel from the support structure for upholstering,
drilling the support structure at the marks to provide a hole to receive a socket component,
driving a socket component into each of the receiving holes in the support structure, the socket component including a cup open to at least one end, an external thread for engaging the support structure, and a constriction in the cup spaced away from the bottom of the cup,
securing a plug component at each of the panel clip locations on the panel, the plug component having a protruding portion to engage in the socket, and
lifting the upholstered panel into position and pressing the periphery into place to engage the protruding portions of the plug components within the cups of the sockets.

22. The method of claim 21, wherein the step of temporarily securing includes screwing the un-upholstered panel to the support.

23. The method of claim 21, wherein the step of marking the support includes drilling a hole through the panel at the clip location, the hole extending into the support.

24. The method of claim 23, wherein the hole is a pilot hole and the method includes the subsequent step of drilling out the pilot hole of the panel to a size suitable for receiving a mounting portion of the plug component.

25. The method of claim 23, wherein the hole is an appropriately dimensioned hole for a mounting portion of the plug component.

26. The method of claim 21, further comprising upholstering the panel after removal from temporary support on the support structure and before installation with the plug components.

27. A method of installing a panel that is already upholstered comprising:
installing a plurality of socket components in a supporting structure,
fitting a center marking tool into each socket, the tool including a point that is centred relative to the socket and protrudes from the socket,
lifting the panel into place and pressing against the socket so that the marking tool leaves an impression in the reverse face of the panel,
securing a plurality of plug components to the panel, each plug component being centered on the location of an impression thus formed,
removing the centre marking tools from the sockets, and
lifting the panel into place and pressing the panel to engage the plug components in the socket components.

28. The method of claim 27, further comprising drilling holes in the panel at each of the impressions and screwing the plug components into the holes.

29. The method of claim 27, further comprising removing the center marking tools by pulling on a tab extending beyond an edge of the socket.

30. The method of claim 27, further comprising fitting the center marking tool by engaging a body portion of the tool in the socket.
